(19) United States
(12) Patent Application Publication
(10) Pub. No.: US 2026/0264281 A1
(43) Pub. Date: Sep. 10, 2026

(54) MULTI-ANGLE FREE USE HANDLE AND SHAVER

(71) Applicant: Yao ZHANG, Ya'an City (CN)

(72) Inventor: Yao ZHANG, Ya'an City (CN)

(21) Appl. No.: 18/996,633

(22) PCT Filed: Jul. 17, 2023
(86) PCT No.: PCT/CN2023/107731

§ 371 Date: Nov. 26, 2025

(30) Foreign Application Priority Data
Aug. 1, 2022 (CN) 202222011600.0
May 31, 2023 (CN) 202310629239.4

(51) Int. Cl. B26B 21/52

(52) U.S. Cl. CPC B26B 21/523

(57) ABSTRACT

A multi-angle free-use handle and shaver, including: a handle body, wings symmetrically outwardly formed on two sides in the width direction, wherein the top surfaces of the wings form two symmetrically-arranged first gripping surfaces, and second gripping surfaces are formed on the bottom surfaces of the wings; a rotating apparatus arranged in the middle of each second gripping surface, wherein the rotating apparatus dividing the handle body into a first handle block and a second handle block along the central axial direction of the wings; the rotating apparatus comprising a first contact surface, a second contact surface and a rotating shaft; the first contact surface being arranged on an end surface of the first handle block, the second contact surface being arranged on an end surface of the second handle block, and the first contact surface and second contact surface abutting one another.

### CROSS-REFERENCE TO RELATED APPLICATIONS

This application claims priority under 35 U.S.C. §119(a) to Chinese Utility Model Patent No. 202222011600.0 filed on Aug. 1, 2022, and to Chinese Patent Application No. 202310629239.4 filed on May 31, 2023, which are hereby incorporated by reference herein in their entirety.

### TECHNICAL FIELD

The application pertains to the realm of shaver components, specifically relates to a multi-angle free use handle and shaver.

### BACKGROUND ART

Currently, shaver handles are commonly designed in a cylindrical shape, which offers convenience for users to grip. However, the gripping method tends to be monotonous. When the use shaves by gripping the shaver, the shaving direction and angle are adjusted primarily by rotating the wrist and altering the hand posture, to ensure the shaver remains in close contact with the various facial shaving surfaces. Moreover, each shaving motion involves repetitive back and forth swings of the forearm. The shaving procedure requires significant wrist rotation, adjustments in grip position, and a continuous forearm swinging. The method of shaving consumes much energy, and there is a risk of the shaver slipping when changing gripping postures (If the shaver is gripped by fingers, the flexibility of fingers allows for adjustment of the shaver head angle by the cooperation of different fingers. The gripping postures enable each shaving action to be performed through wrist rotation alone, eliminating the need for repetitive forearm swings and conserving the energy), resulting in a poor shaving experience, especially for whiskers.

Additionally, to ensure the shaver remains clean every day, it often requires a separate magnetic or embedded fixed base. The use of magnetic or embedded methods to ensure that the shaver is in an upright position, but the arrangement can be inconvenient for users in terms of daily handling and placement, and weaken the overall user experience. Furthermore, an independent base also increases production costs, occupies additional space in the user's environment.

Hence, finding a solution to offer a handle that allows for multi-angle free use while ensuring a high-quality user experience has become a pressing technical challenge.

### SUMMARY

The application provides a multi-angle free use handle and shaver, to address the technical challenge posed by the limited freedom in use at various angles and the poor user experience associated with shaver handles of prior art.

In the first aspect, the application presents a handle designed for multi-angle free use. The handle comprises:

A handle body. The handle body extends wings symmetrically outward along both sides of the width direction. The top surfaces of these wings are designed as concave curved surfaces, forming two first gripping surfaces symmetrically. The bottom surfaces of the wings form a second gripping surface.

A rotating device. The rotating device is positioned at the center of the second gripping surface, dividing the second gripping surface into a third gripping surface and a fourth gripping surface. The rotating device divides the handle body into a first handle block and a second handle block.

The rotating device includes a first contact surface, a second contact surface, and a rotating axis. The first contact surface is located on the end face of the first handle block, while the second contact surface is positioned on the end face of the second handle block. The first contact surface and the second contact surface are abutted, enabling the separation of the first handle block and the second handle block through the rotational movement of the rotating axis.

Optionally, the top surface of handle body is a smooth rounded end face, and smoothly connected to the end part of the first gripping surface and the end part of the fourth gripping surface. The handle body is provided with a holding recess, and the holding recess is designed to hold the corresponding position of the third gripping surface that is abutted by the smooth rounded end face through the rotation around the rotating axis by, and the separation of, the first handle block and the second handle block.

Optionally, the handle further comprises:

An auxiliary lasso. The auxiliary lasso includes a fixed rod and a rotating lasso. The fixed rod runs through the second handle block, and is positioned below the holding recess. The rotating lasso is fixed at both ends of the fixed rod, allowing the rotating lasso to rotate within a range of 0 to 180° around the fixed rod. The rotating lasso is also used to fix the smooth rounded end face of the first handle block when the first handle block is abutted to the corresponding position of the third gripping surface through the rotation around the rotating axis by, and the separation of, the first handle block and the second handle block.

Optionally, the second handle block is equipped with fixing recesses on both sides. The fixing recesses have an axis perpendicular to the axis of the fixing rod, so as to fix the rotating lasso that rotates around the fixing rod.

Optionally, the upper connecting position of the two first gripping surfaces is provided with a convex surface. The convex surface is distributed along the axis line of the handle body and have a bearing plane at the end of the convex surface.

Optionally, the surface of the bearing plane is equipped with a third anti-slip groove and/or a third anti-slip projection; and/or,

The convex surface is equipped with a second anti-slip groove and/or a second anti-slip projection; and/or

Both the first gripping surface and the second gripping surface are equipped with multiple first anti-slip grooves and/or multiple first anti-slip projections.

Optionally, the second handle block is symmetrically furnished with a flat surface at its end. The flat surface is a rough surface, to offers multiple clamping or gripping options by cooperating with the first gripping surface, the second gripping surface, the third gripping surface, the fourth gripping surface, or the convex surface.

Optionally, the first contact surface and the second contact surface include a smooth serrated surface, a smooth curved surface, or a smooth irregular surface, respectively. The first contact surface and the second contact surface are engaged with each other.

Optionally, the maximum depth from the first contact surface to the end face of the first handle block is the same as the maximum depth from the second contact surface to the end face of the second handle block. Furthermore, the maximum distance from the first contact surface to the end face of the first handle block is greater than or equal to the radius of the rotating axis.

In the second aspect, the application introduces a multi-angle free use shaver, and the shaver includes a handle described in the first aspect.

The technical solution provided by the application embodiment offers the following advantages compared to the prior art:

The application embodiment provides a multi-angle free use handle. The design offers several advantages compared to conventional shavers. Wings are formed along the width direction of the traditional cylindrical handle bases, so as to form two symmetrically arranged first gripping surfaces, and the bottom surfaces of the wings form a second gripping surface. The top surfaces of the wings are concave curved surfaces, and the two first gripping surfaces and second gripping surfaces are arranged in a triangular pattern. The unique design allows people to grip the first gripping surface with the thumb and the middle finger, and grip the second gripping with the index finger, to effective grip and fix the handle with only three fingers. Moreover, by arranging a rotational axis in the middle of the second gripping surface, not only can the second gripping surface be separated into the third gripping surface and the fourth gripping surface, but also in the three-finger clamping mode, the raised rotating axis 23 can be placed closely at the joint between the first and second dactylopods of the index finger, while the third gripping surface and the fourth gripping surface can perfectly fit the first and second dactylopods, enhancing slip resistance. Additionally, the handle can be used in a horizontal gripping mode (with four fingers on top and the thumb at the bottom), and the middle and ring fingers grip the third gripping surface and the fourth gripping surfaces respectively, while the index finger's pad holds the bottom end of the second handle block, and the thumb directly grips the top surface of the second handle block. The fingers align along the cross-sectional direction of the handle, offering a different gripping option from the vertical three-finger gripping. Both gripping modes facilitate optimal contact between the shaver head and the human face. When it is required to adjust multiple angles, only by rotating or adjusting the gripping angles of different fingers, users can achieve multi-angle and free movement and rotation of the blade body, enhancing freedom, precision, and shaving comfort. At the same time, with a rotating device, the first contact surface and second contact surface can form a self-standing support surface, realizing a convenient storage of the shaver after use, enhancing overall user experience.

### BRIEF DESCRIPTION OF THE DRAWINGS

The drawings are incorporated into and form an integral part of the manual of instruction, demonstrate the embodiments consistent with the application, and are used to illustrate the principles of the application together with the manual of instruction.

For a clearer presentation of the technical solutions of the application embodiment or prior art. The following is a concise description of the drawings that will be referenced in the application embodiment or prior art. It is obvious that other drawings can be obtained based on these drawings without any creative effort on the part of common technicians in the art.

FIG. 1A structure diagram of a handle provided by the application embodiment;

FIG. 2A structure diagram of another handle provided by the application embodiment;

FIG. 3A structure diagram of the handle provided by the application embodiment during deformation process;

FIG. 4A structure diagram of the handle characterized by smooth curved surfaces of the first contact surface and the second contact surface in the self-standing stage provided by the application embodiment;

FIG. 5A structure diagram of the handle characterized by smooth serrated surfaces of the first contact surface and the second contact surface in the self-standing stage provided by the application embodiment; and

FIG. 6A structure diagram of the handle characterized by smooth irregular surfaces of the first contact surface and the second contact surface in the self-standing stage provided by the application embodiment

FIG. 7A structure diagram of the handle provided by the application embodiment from another angle

FIG. 8A bottom view of the structure of the handle provided by the application embodiment

Wherein, 1—handle body, 11—first handle block, 12—second handle block, 121—holding recess, 122—fixed recess, 123—flat surface, 13—wing, 2—rotating device, 21—first contact surface, 22—second contact surface, 23—rotating axis, 3—smooth rounded end, 4—auxiliary lasso, 41—fixing rod, 42—rotating lasso, 5—first gripping surface, 51—first anti-slip groove, 6—second gripping surface, 7—third gripping surface, 8—fourth gripping surface, 9—convex surface, 91—bearing plane, 92—second anti-slip groove, 93—third anti-slip groove.

### DETAILED DESCRIPTION

To provide a clearer understanding of the purpose, technical solutions, and advantages of the application embodiment, the following description, in conjunction with the accompanying drawings, provides a comprehensive and detailed explanation of the technical solutions of the application embodiment. It should be noted that the application embodiment is merely one part of the embodiments of the application and do not represent all embodiments. The scope of protection of the application includes all other application embodiments that common technicians in the field can obtain without creative labor based on the application embodiments.

It should be noted that the directional terms (such as up, down, left, right, forward, backward, etc.) used in the embodiment of the invention are only for the purpose of describing the relative positions, movements, etc. of the components in a specific posture (as shown in the drawings). If the posture is changed, the directional terms will be adjusted accordingly.

In the invention, unless specifically stated and limited, the terms “connection” and “fixing” are understood in a broad sense. For example, “fixing” can refer to a connection that is permanently connected, detachably connected, or formed into a single unit. It can involve various types of connections, including mechanical or electrical connections. The connection can be direct or indirect, and can involve the use of a medium. It can also refer to an internal communication between two components or the interactive relationship between two components, unless explicitly stated otherwise. To a common technician in the field, the specific meaning of the above terms in the invention can be understood on a case-by-case basis.

Furthermore, if there is a mention of “first,” “second” or other ordinal numerals in the invention, such descriptions are solely for illustrative purposes. They should not be interpreted as indicating or suggesting relative significance or implicitly specifying the number of technical characteristics indicated. Therefore, characteristics labeled as “first” and “second” may explicitly or implicitly encompass at least one corresponding feature. Moreover, the term “and/or” appearing in the text refers three parallel solutions, taking “A and/or B” as example, it implies that the solution can encompass either the A solution, the B solution, or both the A and B solutions simultaneously. Furthermore, the technical solutions of various embodiments can be combined with each other, but it should be based on the conditions that common technicians in the field can accomplish the solution. If the combination of technical solutions contradicts with each other or cannot be feasibly achieved, it should be considered that such a combination does not exist and falls outside the scope of protection provided by the invention.

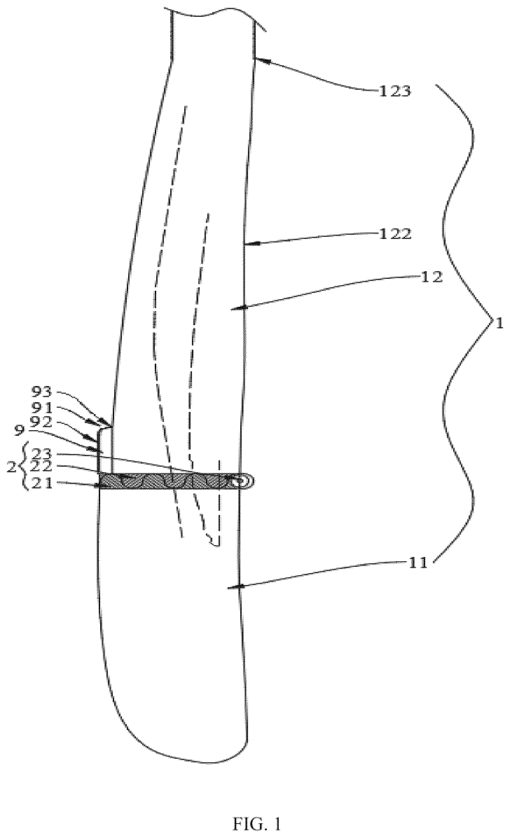

As depicted in FIGS. 1 and 7, the application embodiment discloses a multi-angle free use handle. The handle contains the following components:

A handle body 1. The handle body 1 incorporates symmetrically positioned wings 13 extending outward on both sides along the width direction. Each of the wings 13 has a concave top surface, to form two symmetrically placed first gripping surfaces 5. The bottom surfaces of the wings 13 flushes with the bottom of the handle body 1, to form a second gripping surface 6. In other words, the bottom of the handle body 1 is formed by the bottom surfaces of the wings 13, which serve as the second gripping surface 6.

A rotating device 2. The rotating device 2 is positioned in the center of the second gripping surface 6, to divide the second gripping surface 6 into a third gripping surface 7 and a fourth gripping surface 8. The rotating device 2 divide the handle body 1 into a first handle block 11 and a second handle block 12 along the central axis of the wing 13;

The rotating device 2 comprises a first contact surface 21, a second contact surface 22, and a rotating axis 23. The first contact surface 21 is situated on the end face of the first handle block 11, while the second contact surface 22 is located on the end face of the second handle block 12. The first contact surface 21 and the second contact surface 22 are abutted, enabling the separation of the first handle block 11 and the second handle block 12 through the rotational movement of the rotating axis 23.

In the application embodiment, the rotating axis 23 also has certain positioning function. When the user intends to utilize the lateral clamping mode, they can easily locate the third gripping surface 7 and the fourth gripping surface 8 by touching the rotating axis 23, which facilitate the use.

Simultaneously, the areas of the two handle blocks corresponding to the rotating axis 23 are the thickest parts of the handle. This kind of design can ensure to clamp and pull back the shaver with three fingers to the largest extent before shaving, without the risk of accidental falling due to insufficient clamping force.

The end of the first handle block 11 can be a curved surface, to ensure the comfort of different gripping or clamping modes.

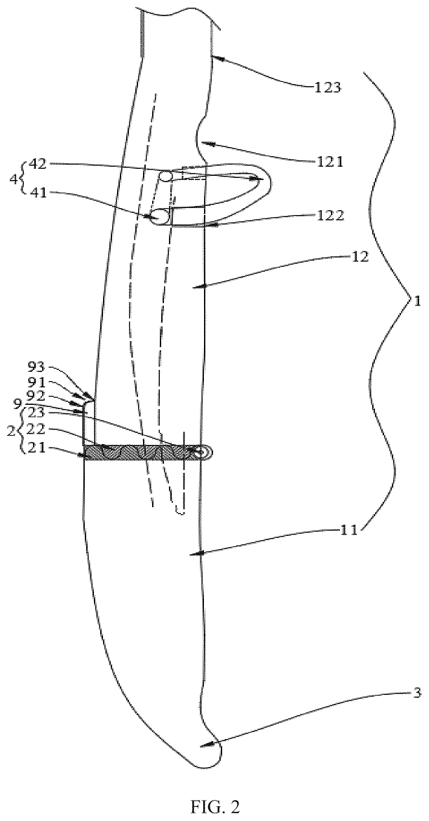

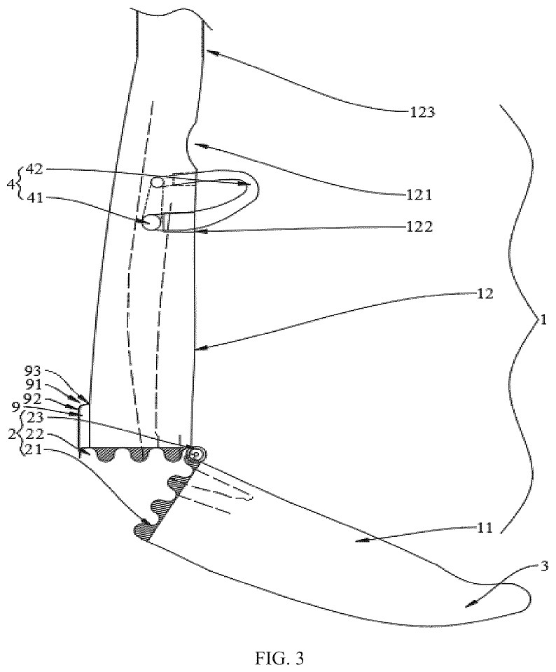

In some optional embodiments depicted in FIGS. 2 and 3, the handle body 1 is provided with a smooth rounded end face 3 on its top surface, and forms a seamless connection with the end parts of the first gripping surface 5 and of the fourth gripping surface 8. The handle body 1 is provided with a holding recess 121, and the holding recess 121 is designed to hold the corresponding position of the third gripping surface that is abutted by the smooth rounded end face 3 through the rotation around the rotating axis by, and the separation of, the first handle block and the second handle block.

In the application embodiment, the handle body 1 is provided with a smooth rounded end face 3 along with a holding recess 121 to hold the smooth rounded end face 3, and the holding recess 121 is restricted, to ensure a close adhesion between the smooth rounded end face 3 of the first handle block 11 and the holding recess 121 of the second handle block 12. This adhesion can fix the rotating state of the fixed rotating axis 23 and ensure forming a stable upright support surface between the first contact surface 21 of the first handle block 11 and the second contact surface 22 of the second handle block 12. As a result, the handle can stand upright independently, realizing a convenient storage of the shaver use, enhancing overall user experience.

Additionally, the handle body 1 incorporates a smooth rounded end surface 3 on its top surface. This design feature distinguishes it from traditional straight rod handles that tend to have a heavier and larger end part. In comparison to conventional shavers, when the shaver of the invention is in use, force must be applied forward to the blade head for pressing close to the skin; the design of a smooth rounded end surface 3 can increase the weight of tail of the handle body 1, making it easier for the shaver head to naturally tilt forward, ensuring closer proximity to the user's skin.

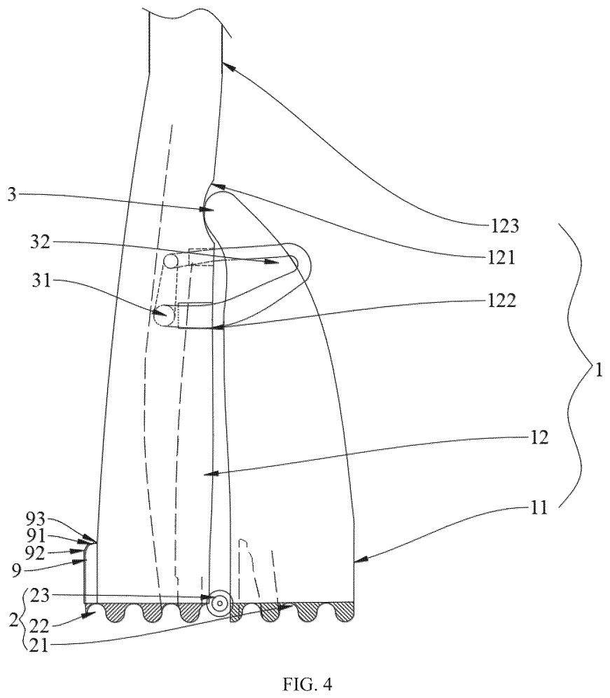

As shown in FIG. 4, in some optional application embodiments, the handle further comprises:

An auxiliary lasso 4. The auxiliary lasso 4 includes a fixing rod 41 and a rotating lasso 42. The fixing rod 41 passes through the second handle block 12 and is positioned below the holding recess 121. The rotating lasso 42 is fixed to both ends of the fixing rod 41, allowing the rotating lasso to rotate within a range of 0 to 180° around the fixing rod 41. The rotating lasso is also used to fix the smooth rounded end face 3 of the first handle block 11 when the first handle block is abutted to the corresponding position of the third gripping surface through the rotation around the rotating axis by, and the separation of, the first handle block and the second handle block.

In the application embodiment, the handle body 1 is provided with an auxiliary lasso 4, the rotating angle of the rotating lasso 42 in the auxiliary lasso 4 is restricted. The rotating lasso 42 can serve as an auxiliary fixing structure during normal using process of the shaver; moreover, when the shaver is gripped vertically with three fingers, the vertical rotating lasso 42 can circle the first dactylopod of the index finger, enhancing the shaver's anti-slip properties. When the shaver is gripped horizontally (with four fingers on top and the thumb at the bottom), the rotating lasso 42 can be put down in the holding recess 121, which can make the user consider the depression of the holding recess as a large depression area formed by the extension of the rotating lasso 42. The design allows for a more stable placement of the finger pad of index finger in this position, improving anti-slip properties in the horizontal clamping posture, thus facilitating the free use from various angles.

Furthermore, when the handle is in upright position, it can be used to securely fasten the first handle block 11 and the second handle block 12 together by utilizing the elastic force of the rotating lasso 42. This can fix the rotating state of the rotating axis 23, and stabilize the upright status of the handle, facilitating the storage of the shaver after use, enhancing overall user experience.

In certain optional application embodiments, the second handle block 12 is provided with fixing recesses 122 on both sides. The axis of fixing recesses 122 are perpendicular to the axis of the fixing rod 41, so as to fix the rotating lasso 42 rotating around the fixing rod 41.

In the application embodiment, fixing recesses 122 are provided at both sides of the second handle block 12. When the rotating lasso 42 is upright and circles the index finger or tie up the top surface of the first handle block 11, it can ensure the stabile using of the rotating lasso 42, fixing the rotating state of the rotating axis 23, facilitating storage of the shaver and improving user experience.

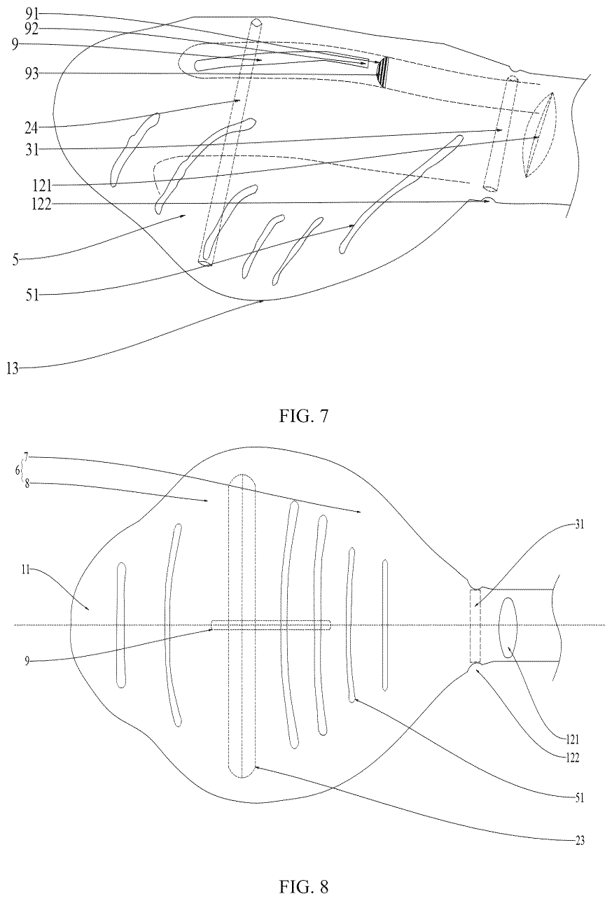

In certain optional application embodiments depicted in FIGS. 7 and 8, a convex surface 9 is provided at the top connection between the two first gripping surfaces 5. The convex surface 9 is distributed along the axis of the handle body 1, with a bearing plane 91 at its end.

In certain optional application embodiments, the surface of the bearing plane 91 is equipped with a third anti-slip groove 93 and/or a third anti-slip projection; and/or

The surface of the convex surface 9 is provided with a second anti-slip groove 92 and/or a second anti-slip projection; and/or

The first gripping surface 5 and the second gripping surface 6 are provided with multiple first anti-slip grooves 51 and/or first anti-slip projections.

In the application embodiment, the first gripping surface 5 and the second gripping surface 6 are provided with first anti-slip grooves 51 and/or first anti-slip projections. Anti-slip grooves or anti-slip projections can be provided based on the sensitivity of different fingers, to increase the roughness of the first gripping surface 5 and the second gripping surface 6, thus enhancing the friction coefficient of the handle, improving the user's experience, and ensuring the stability in multi-angle free use.

The introduction of the convex surface 9 and bearing plane 91 enhances the contact area and contact angle between the thumb and the second handle block 12. Additionally, the introduction of the second anti-slip groove 92 or the second anti-slip projection, as well as the third anti-slip groove 93 or the third anti-slip projection can further increase the friction between the thumb and the second handle block 12, and further guarantee the smooth and comfortable use by lateral gripping. Furthermore, the first gripping surface 5 and the second gripping surface 6 are provided with the first anti-slip groove 51 or multiple first anti-slip projections, to improve the friction coefficient of the first gripping surface 5 and the second gripping surface 6. This effectively prevents the handle from slipping during the three-finger gripping, and increase the freedom of free multi-angle use of shaver.

With the aforementioned design, the two first gripping surfaces 5 and the second gripping surfaces 6 are arranged in a triangular pattern. This allows the handle to be securely held and fixed by gripping the two first gripping surfaces 5 with the thumb and middle finger, and gripping the second gripping surface 6 with the index finger. This three-finger gripping enables can fit the blade to the human face; moreover, the raised rotating axis 23 can be placed closely at the joint between the first and second dactylopods of the index finger, while the third gripping surface and the fourth gripping surface can perfectly fit the first and second dactylopods, enhancing the slip resistance. When the horizontal gripping mode (four fingers on top and thumb at the bottom) is adopted, the middle finger and ring finger grip the third gripping surface 7 and the fourth gripping surface 8, respectively. The pad of the index finger grips the holding recess 121, while the thumb directly grips the top surface of the second handle block 12 (i.e., the aforementioned raised surface 9). In this gripping mode, the fingers are aligned along the cross-sectional direction of the first handle block 11 and the second handle block 12, which is a gripping mode different from vertical three-finger gripping mode (here the fingers align along the axis of the first handle block 11 and the second handle block 12)

Upon completion of shaving, the user can rotate the rotating axis 23 in the rotating device 2, rotate the first handle block 11 to the parallel direction of the second handle block 12. In this position, the first contact surface and the second contact surface of the two handle blocks jointly form a support surface, while smooth rounded end surface 3 located at the end of the user's first handle block 11 is held closely into the holding recess 121 of the second handle block 12, which make the handle body 1 maintain a self-standing position without the need of introducing the fixing mode with a magnetic fixing base or an embedded fixing base. This allows users to easily store the shaver.

In certain optional application embodiments, the end of the second handle block 12 is symmetrically equipped with a flat surface 123. The flat surface 123 is a rough surface, offering various gripping or holding methods by matching with the first gripping surface 5, the second gripping surface 6, the third gripping surface 7, the fourth gripping surface 8, or the convex surface 9.

In the application embodiment, the end of the second handle block 12 is provided with symmetrical and rough flat surface 123, for the convenience of utilizing the five-finger lateral gripping method (the index finger's pad holds the flat surface 123 near the side of the holding recess 121, while the middle finger's pad grips the inside of the holding recess 121. The ring finger and little finger grip the third gripping surface 7 and the fourth gripping surface 8, respectively). The thumb grips the flat surface 123 at the back side of the holding recess 121 to fit closely with the handle, ensuring a stable gripping when using the shaver in a lateral manner, enhancing the overall stability of the handle body 1, thereby improving the freedom of multi-angle use of the shaver.

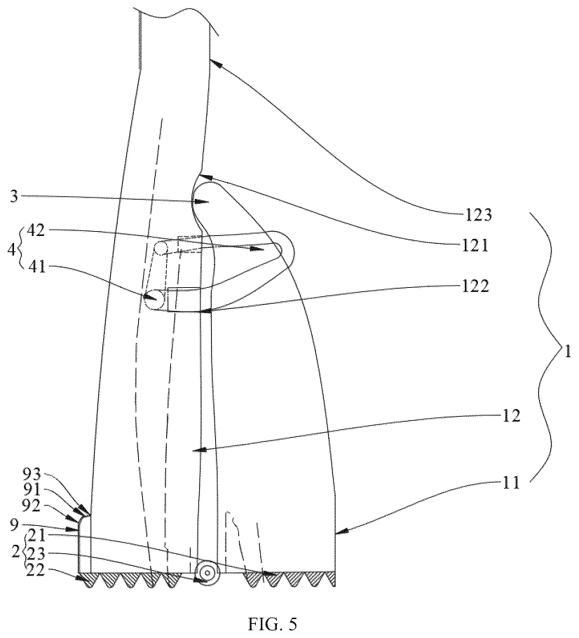

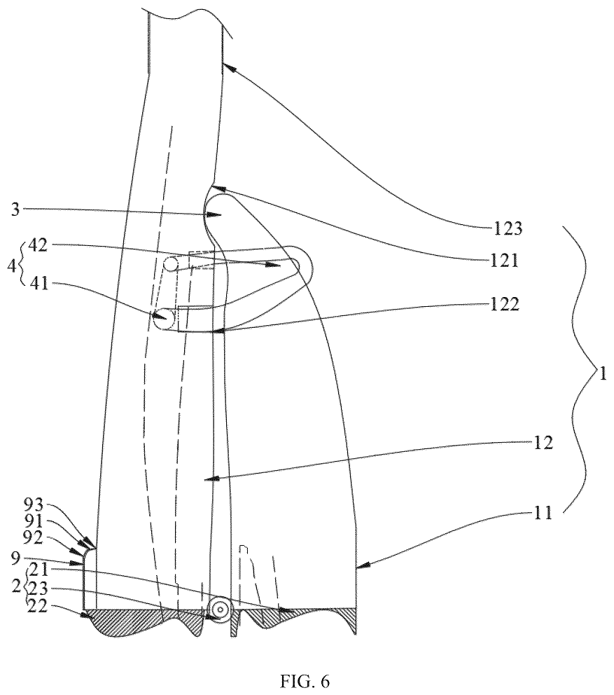

In some optional application embodiments as depicted in FIGS. 5 and 6, the first contact surface 21 and the second contact surface 22 include smooth serrated surfaces, smooth curved surfaces, or smooth irregular surfaces. The first contact surface 21 and the second contact surface 22 are engaged with each other. The shapes of the first contact surface 21 and the second contact surface 22 only need to satisfy the geometric specifications for effecting engagement.

In the application embodiment, a close engagement between the first contact surface 21 and the second contact surface 22 can be guaranteed by restricting the forms of the first contact surface 21 and the second contact surface 22, thus guaranteeing that when the first handle block 11 and the second handle block 12 form the handle body 1, the engagement force between the surfaces can offset the rotational force exerted on the rotating axis 23, to ensure the steady using of the handle body 1, thereby enhancing overall comfort of the user.

When utilizing the smooth serrated surface, to ensure the safety of the user, the first contact surface 21 and the second contact surface 22 are generally made into curved surface, which can not only increase the contact area between the first contact surface 21 and the second contact surface 22, improve the stability of the handle body 1, but also increase the contact area between the first contact surface 21, 22 and the surface of placing platform, enhance the stability of the handle when it is set down, facilitating the picking and placing of the shaver.

In certain optional application embodiments, the maximum depth from the first contact surface 21 to the end face of the first handle block 11 is the same as the maximum depth from the second contact surface 22 to the end face of the second handle block 12. Moreover, the maximum distance between the first contact surface 21 and the end face of the first handle block 11 is greater than or equal to the radius of the rotating axis 23.

In the application embodiment, by restricting the relationship between the maximum depth from the first contact surface 21 and the second contact surface 22 to the end face of their respective handle blocks and the radius size of the rotating axis 23, we can ensure the upright stability of the shaver when the upright support surface is unfolded, and provide support force in the vertical direction, reduce the force exerted on the rotating axis 23, and extend the service life of the rotating axis 23. Moreover, it can raise the first handle block 11 and the second handle block 12, prevent them from direct contacting with water and being wetted, so as to ensure the service life of the first contact surface 21 and the second contact surface 22. Additionally, it reduces the resistance of water flow and prevents the shaver from being washed away, thereby improving the storage stability of the shaver.

Based on an overall technical concept, the application introduces a multi-angle free use shaver. The shaver comprises a handle.

In this application embodiment, the remaining components of the shaver can be selected from any of prior arts that enable the shaver to fulfill its shaving function, such as a conventional blade body or an electric blade body.

The shaver is designed based on the handle described above, and the specific structure of the handle can be referred to the abovementioned application embodiments. As the shaver incorporates some or all of the technical solutions of the above application embodiments, it boasts all beneficial effects of the technical solutions of the above embodiments, which need no further statement.

The process of using the shaver of this invention is as follows: When the user needs to shave, they can rotate the rotating axis 23 located between the first handle block 11 and the second handle block 12, to make the first contact surface 21 of the first handle block 11 and the second contact surface 22 of the second handle block 12 engage with each other. At this time, the first contact surface 21 and the second contact surface 22 may be made from magnetic materials and magnetically attracted together, to form a complete handle. Simultaneously, the rotating lasso in the auxiliary lasso 4 is rotated to the corresponding position (either fixed at a finger position or placed within the holding recess 121), to facilitate the user to grip the shaver with a three-finger vertical clamping or horizontal clamping method, thereby realizing the multi-angle free use of the shaver.

After the shaving process, the first handle block 11 and the second handle block 12 can be separated by rotating them around the rotating axis 23. Consequently, the first contact surface 21 and the second contact surface 22 become disengaged. When the handle blocks 11 and 12 are rotated to a parallel or nearly parallel status, the end of the first handle block 11 is provided with a smooth rounded end face 3. The smooth rounded end face 3 and holding recess 121 can be made from magnetic material, and closely attracted through the attracting force between the smooth rounded end face 3 and the holding recess 121 of the second handle block 12, or through the embedding force between the smooth rounded end face 3 and the holding recess 121 of the second handle block 12. Alternatively, the fixing rod 41 and the rotating lasso 42 in the auxiliary lasso 4 can be utilized to anchor nearby the smooth rounded end face 3 of the first handle block 11, to make the first handle block 11 be stably parallel with or nearly parallel with the second handle block 12. Consequently, the first contact surface 21 and the second contact surface 22 establish a stable upright support surface, making it convenient to place the shaver and enhancing usage convenience.

The aforementioned descriptions are the specific application embodiments of the application, which facilitate the understanding or realizing the application by the technical personnel of the field. The various modifications to these application embodiments are evident to those technicians. The general principles outlined in this application can be realized by other application embodiments without straying from the essential spirit or scope of the application. Hence, the application will not be restricted to the specific application embodiments disclosed herein, but encompasses the broadest scope consistent with the principles and novel characteristics presented in this application.

1. A multi-angle free use handle is characterized by inclusion of the following components:
A handle body. The handle body incorporates symmetrically positioned wings extending outward on both sides along the width direction. The top surfaces of the wings are designed as concave curved surfaces, forming two first gripping surfaces symmetrically, and the bottom surfaces of the wings form a second gripping surface;
A rotating device. The rotating device is positioned in the center of the second gripping surface, effectively dividing the second gripping surface into a third gripping surface and a fourth gripping surface. The rotating device separate the handle body into a first handle block and a second handle block;
The rotating device comprises a first contact surface, a second contact surface, and a rotating axis. The first contact surface is situated on the end face of the first handle block, while the second contact surface is located on the end face of the second handle block, wherein the first contact surface and the second contact surface are made of magnetic materials, and the first contact surface and the second contact surface are abutted, enabling the separation of the first handle block and the second handle block through the rotational movement of the rotating axis.

2. The handle described in claim 1 is characterized in that a handle body with a round and smooth end face on the top surface, and smoothly connected to both the end part of the first gripping surface and the end part of the fourth gripping surface. The handle body is equipped with a holding recess to hold the round and smooth end face.

3. The handle described in claim 2 is characterized in that the handle also include:
An auxiliary lasso. The auxiliary lasso comprises a fixed rod and a rotating lasso. The fixed rod passes through the second handle block and is positioned below the holding recess. The rotating lasso is securely attached at both ends of the fixed rod, allowing the rotating lasso to rotate in a range of 0 to 180° around the fixed rod and fix the round and smooth end face of the first handle block.

4. The handle described in claim 2 is characterized in that fixing recesses are provided on both sides of the second handle block. The axes of these fixing recesses are perpendicular to the axis of the fixing rod so as to fix the rotating lasso rotating around the fixing rod.

5. The handle described in claim 1 is characterized by a convex surface is provided on the upper connecting position of the two first gripping surfaces. The convex surfaces are positioned along the axis of the second handle block, and a bearing plane is located at the end of the convex surfaces.

6. The handle described in claim 5 is characterized by the surface of the bearing plane is provided with a third anti-slip groove and/or a third anti-slip projection; and/or
The surface of the convex surface is equipped with a second anti-slip groove and/or a second anti-slip projection; and/or
Both the first gripping surface and the second gripping surface are furnished with multiple first anti-slip grooves and/or multiple first anti-slip projections.

7. The handle described in claim 5 is characterized in that, the end of the second handle block is symmetrically provided with a flat surface, and the flat surface is a rough surface, so as to cooperate with the first gripping surface, the second gripping surface, the third gripping surface, the fourth gripping surface, or the convex surface, and realize multiple clamping or gripping options.

8. The handle described in claim 1 is characterized in that the first contact surface and the second contact surface respectively include a smooth serrated surface, a smooth curved surface or a smooth irregular surface. The first contact surface and the second surface are engaged with each other.

9. The handle described in claim 1 is characterized in that the maximum depth from the first contact surface to the end face of the first handle block is the same as the maximum depth from the second contact surface to the end face of the second handle block. Moreover, the maximum distance between the first contact surface and the end face of the first handle block is greater than or equal to the radius of the rotating axis.

10. A razor capable of being used freely at multiple angles, characterized in that the razor comprises a handle, and the handle comprises:
A handle body. The handle body incorporates symmetrically positioned wings extending outward on both sides along the width direction. The top surfaces of the wings are designed as concave curved surfaces, forming two first gripping surfaces symmetrically, and the bottom surfaces of the wings form a second gripping surface;
A rotating device. The rotating device is positioned in the center of the second gripping surface, effectively dividing the second gripping surface into a third gripping surface and a fourth gripping surface The rotating device separate the handle body into a first handle block and a second handle block;
The rotating device comprises a first contact surface a second contact surface and a rotating axis. The first contact surface is situated on the end face of the first handle block, while the second contact surface is located on the end face of the second handle block, wherein the first contact surface and the second contact surface are made of magnetic materials, and the first contact surface and the second contact surface are abutted, enabling the separation of the first handle block and the second handle block through the rotational movement of the rotating axis.

1. A multi-angle free use handle is characterized by inclusion of the following components:
A handle body. The handle body incorporates symmetrically positioned wings extending outward on both sides along the width direction. The top surfaces of the wings are designed as concave curved surfaces, forming two first gripping surfaces symmetrically, and the bottom surfaces of the wings form a second gripping surface;
A rotating device. The rotating device is positioned in the center of the second gripping surface, effectively dividing the second gripping surface into a third gripping surface and a fourth gripping surface. The rotating device separate the handle body into a first handle block and a second handle block;
The rotating device comprises a first contact surface a second contact surface and a rotating axis. The first contact surface is situated on the end face of the first handle block, while the second contact surface is located on the end face of the second handle block, wherein the first contact surface and the second contact surface are made of magnetic materials, and the first contact surface and the second contact surface are abutted, enabling the separation of the first handle block and the second handle block through the rotational movement of the rotating axis.

2. The handle described in claim 1 is characterized in that a handle body with a round and smooth end face on the top surface, and smoothly connected to both the end part of the first gripping surface and the end part of the fourth gripping surface. The handle body is equipped with a holding recess to hold the round and smooth end face.

3. The handle described in claim 2 is characterized in that the handle also include:
An auxiliary lasso. The auxiliary lasso comprises a fixed rod and a rotating lasso. The fixed rod passes through the second handle block and is positioned below the holding recess. The rotating lasso is securely attached at both ends of the fixed rod, allowing the rotating lasso to rotate in a range of 0 to 180° around the fixed rod and fix the round and smooth end face of the first handle block.

4. The handle described in claim 2 is characterized in that fixing recesses are provided on both sides of the second handle block. The axes of these fixing recesses are perpendicular to the axis of the fixing rod so as to fix the rotating lasso rotating around the fixing rod.

5. The handle described in claim 1 is characterized by a convex surface is provided on the upper connecting position of the two first gripping surfaces. The convex surfaces are positioned along the axis of the second handle block, and a bearing plane is located at the end of the convex surfaces.

6. The handle described in claim 5 is characterized by the surface of the bearing plane is provided with a third anti-slip groove and/or a third anti-slip projection; and/or
The surface of the convex surface is equipped with a second anti-slip groove and/or a second anti-slip projection; and/or
Both the first gripping surface and the second gripping surface are furnished with multiple first anti-slip grooves and/or multiple first anti-slip projections.

7. The handle described in claim 5 is characterized in that, the end of the second handle block is symmetrically provided with a flat surface, and the flat surface is a rough surface, so as to cooperate with the first gripping surface, the second gripping surface, the third gripping surface, the fourth gripping surface, or the convex surface, and realize multiple clamping or gripping options.

8. The handle described in claim 1 is characterized in that the first contact surface and the second contact surface respectively include a smooth serrated surface, a smooth curved surface or a smooth irregular surface. The first contact surface and the second surface are engaged with each other.

9. The handle described in claim 1 is characterized in that the maximum depth from the first contact surface to the end face of the first handle block is the same as the maximum depth from the second contact surface to the end face of the second handle block. Moreover, the maximum distance between the first contact surface and the end face of the first handle block is greater than or equal to the radius of the rotating axis.

10. A razor capable of being used freely at multiple angles, characterized in that the razor comprises a handle, and the handle comprises:
A handle body. The handle body incorporates symmetrically positioned wings extending outward on both sides along the width direction. The top surfaces of the wings are designed as concave curved surfaces, forming two first gripping surfaces symmetrically, and the bottom surfaces of the wings form a second gripping surface;
A rotating device. The rotating device is positioned in the center of the second gripping surface, effectively dividing the second gripping surface into a third gripping surface and a fourth gripping surface. The rotating device separate the handle body into a first handle block and a second handle block;
The rotating device comprises a first contact surface a second contact surface and a rotating axis. The first contact surface is situated on the end face of the first handle block, while the second contact surface is located on the end face of the second handle block, wherein the first contact surface and the second contact surface are made of magnetic materials, and the first contact surface and the second contact surface are abutted, enabling the separation of the first handle block and the second handle block through the rotational movement of the rotating axis.
